(19) United States
(12) Patent Application Publication
(10) Pub. No.: US 2023/0291012 A1
(43) Pub. Date: Sep. 14, 2023

(54) ELECTROLYTIC SOLUTION FOR LITHIUM SECONDARY BATTERIES AND LITHIUM SECONDARY BATTERY INCLUDING THE SAME

(71) Applicants: Hyundai Motor Company, Seoul (KR); Kia Corporation, Seoul (KR); The Industry & Academic Cooperation in Chungnam National University (IAC), Daejeon (KR)

(72) Inventors: Ko Eun Kim, Cheongju (KR); Seung Min Oh, Incheon (KR); Yoon Sung Lee, Suwon (KR); Hui Beom Nam, Hwaseong (KR); Jun Ki Rhee, Suwon (KR); Sung Ho Ban, Hwaseong (KR); Seung Wan Song, Sejong (KR); Min Geun Oh, Daejeon (KR)

(21) Appl. No.: 17/981,878

(22) Filed: Nov. 7, 2022

(30) Foreign Application Priority Data
Mar. 11, 2022 (KR) 10-2022-0030793

(51) Int. Cl. H01M 10/0567; H01M 10/0525

(52) U.S. Cl. CPC H01M 10/0567; H01M 10/0525; H01M 2220/20; H01M 2300/0025

(57) ABSTRACT

Disclosed are an electrolytic solution for lithium secondary batteries capable of improving lifespan characteristics of a lithium secondary battery under a high voltage condition and a lithium secondary battery including the same. The electrolytic solution includes a lithium salt, a solvent, and a functional additive, and the functional additive includes a high-voltage additive including a first high-voltage additive, perfluoro-15-crown-5-ether, represented by [Formula 1] and a second high-voltage additive, fluoroethylene carbonate, represented by [Formula 2].

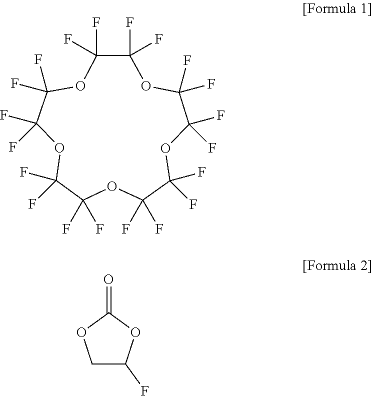 [SMILES: FC1(F)OC(F)(F)C(F)(F)OC(F)(F)C(F)(F)OC(F)(F)C(F)(F)OC(F)(F)C(F)(F)OC1(F)F ; O=C1OCC(F)O1]

### CROSS-REFERENCE TO RELATED APPLICATION

This application claims the benefit of Korean Patent Application No. 10-2022-0030793, filed on Mar. 11, 2022, with the Korean Intellectual Property Office, the disclosure of which is herein incorporated by reference in its entirety.

### TECHNICAL FIELD

The present invention relates to an electrolytic solution for lithium secondary batteries and a lithium secondary battery including the same, which are capable of improving lifespan characteristics of a lithium secondary battery under a high voltage condition and a lithium secondary battery including the same.

### BACKGROUND

A lithium secondary battery is an energy storage device including a positive electrode configured to provide lithium during charging, a negative electrode configured to receive lithium during charging, an electrolyte serving as a lithium ion transfer medium, and a separator configured to separate the positive electrode and the negative electrode from each other. The lithium secondary battery generates and stores electric energy through a change in chemical potential when lithium ions are intercalated/deintercalated at the positive electrode and the negative electrode.

The lithium secondary battery has been mainly used in portable electronic devices. In recent years, however, the lithium secondary battery has also been used as an energy storage means of an electric vehicle (EV) and a hybrid electric vehicle (HEV) as the electric vehicle and the hybrid electric vehicle are commercialized.

Meanwhile, research to increase the energy density of the lithium secondary battery in order to increase the range of the electric vehicle has been conducted. The energy density of the lithium secondary battery may be increased by increasing the capacity of the positive electrode.

The capacity of the positive electrode may be increased by using a Ni-rich method, which is a method of increasing the content of Ni in a Ni—Co—Mn oxide forming a positive electrode active material, or by increasing positive electrode charging voltage to a high voltage.

However, the Ni-rich Ni—Co—Mn oxide has an unstable crystalline structure while exhibiting high interfacial reactivity, whereby degradation during cycles is accelerated and thus it is difficult to secure long-term performance of the lithium secondary battery.

In other words, the positive electrode made of the Ni-rich Ni—Co—Mn oxide has problems in that oxidative decomposition of the electrolytic solution, interfacial reaction between the positive electrode and the electrolytic solution, metal elution, gas generation, phase change into an inactive cubic state, increase in metal deposition at the negative electrode, increase in interfacial resistance of the battery, accelerated degradation, charging and discharging performance degradation, and instability at high temperatures are caused due to high content of Ni and high reactivity of Ni⁴⁺ formed in the electrolytic solution during charging, whereby safety and lifespan of the battery are reduced

In addition, research and development of a silicon-graphite negative electrode active material including silicon have been continuously conducted to increase the capacity of the negative electrode in conjunction with an increase in capacity of the positive electrode. However, there is still a problem in that the lifespan of the battery is reduced due to a change in volume of silicon and interfacial instability.

In other words, for a silicon-graphite negative electrode, lattice volume is increased to 300% or greater during charging, volume is decreased during discharging, Si surface inactivation chemical species are formed in large quantities due to interfacial reaction with LiPF₆ salt, and safety and lifespan of the battery are reduced due to low coverage of SEI, low mechanical strength, increase in interfacial resistance, performance degradation, gas generation, and consumption of the electrolytic solution.

The matters disclosed in this section are merely for enhancement of understanding of the general background of the invention and should not be taken as an acknowledgment or any form of suggestion that the matters form the related art already known to a person skilled in the art.

### SUMMARY

In preferred aspects, provided is an electrolytic solution for lithium secondary batteries capable of simultaneously improving SEI stability of a silicon-graphite negative electrode and SEI stability of a positive electrode under a high voltage condition, thereby securing stability in charging and discharging performance of a high-capacity positive electrode, and a lithium secondary battery including the same.

Objects of the present invention are not limited to the aforementioned object, and other unmentioned objects will be clearly understood by those skilled in the art based on the following description.

In an aspect, provided is an electrolytic solution for lithium secondary batteries that includes a lithium salt, a solvent, and a functional additive. In particular, the functional additive may include a high-voltage additive including a first high-voltage additive and a second high-voltage additive.

A term “high-voltage additive” as used herein refers to a component for an electrolyte solution component of lithium secondary battery, and a particular component contributing to improving SEI stability of, e.g., a silicon-graphite negative electrode and/or a positive electrode, under a high voltage condition, e.g., greater than about 2.0 V, greater than about 2.5 V, greater than about 3.0V, greater than about 3.5 V, greater than about 4.0 V, or in a range of about 2.0 V to 4.5V.

The first and second high-voltage additives may be independently functioning and, may be the same or different type. For example, if the first and second high-voltage additives are different, the first high-voltage additive and the second high-voltage additive may have different chemical properties such as reducing capacity or ability for oxidative stability of the electrolytic solution.

In particular, the first high-voltage additive may include perfluoro-15-crown-5-ether having a structure of Formula 1 and the second high-voltage additive may include fluoroethylene carbonate having a structure of Formula 2.

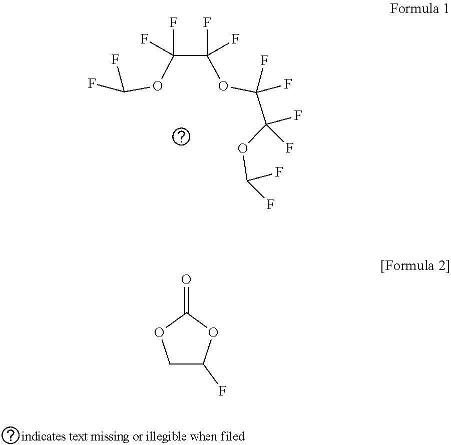 [SMILES: FC(F)OC(F)(F)C(F)(F)OC(F)(F)C(F)(F)OC(F)F ; O=C1OCC(F)O1]

The electrolytic solution may suitably include the high-voltage additive in an amount of about 0.7 to 4.0 wt % based on the total weight of the electrolytic solution.

The electrolytic solution may suitably include the first high-voltage additive in an amount of about 0.2 to 1.5 wt % based on the weight of the electrolytic solution, and the electrolytic solution may suitably include the second high-voltage additive in an amount of about 0.5 to 2.5 wt % based on the total weight of the electrolytic solution.

The electrolytic solution may suitably include the high-voltage additive in an amount of about 1.4 to 3.0 wt % based on the total weight of the electrolytic solution.

The electrolytic solution may suitably include the first high-voltage additive in an amount of about 0.4 to 1.0 wt % based on the total weight of the electrolytic solution, and the electrolytic solution may suitably include the second high-voltage additive in an amount of about 1.0 to 2.0 wt % based on the total weight of the electrolytic solution.

The functional additive may further include vinylene carbonate (VC) as a negative electrode film additive.

The electrolytic solution may suitably include the negative electrode film additive in an amount of about 0.5 to 3.0 wt % based on the total weight of the electrolytic solution.

The electrolytic solution may suitably include the functional additive in an amount of about 5 wt % or less based on the total weight of the electrolytic solution.

The electrolytic solution may suitably include the first high-voltage additive in an amount of about 0.4 to 1.0 wt % based on the total weight of the electrolytic solution, the electrolytic solution may suitably include the second high-voltage additive in an amount of about 1.0 to 2.0 wt % based on the weight of the electrolytic solution, and the electrolytic solution may suitably include the negative electrode film additive in an amount of about 1.5 to 2.5 wt % based on the total weight of the electrolytic solution.

The lithium salt may suitably include one or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N (LiFSI), and (CF₃SO₂)₂NLi.

The solvent may suitably include one or more selected from the group consisting of a carbonate-based solvent, an ester-based solvent, an ether-based solvent, and a ketone-based solvent.

In an aspect, provided is a lithium secondary battery including the electrolytic solution as described herein. The lithium secondary battery may further include a positive electrode including a positive electrode active material including Ni, Co, and Mn, a negative electrode including one or more selected from among carbon (C)-based and silicon (Si)-based negative electrode active materials, and a separator interposed between the positive electrode and the negative electrode.

The positive electrode may suitably include the Ni in an amount of about 80 wt % or greater based on the total weight of the positive electrode.

Also provided is a vehicle including the lithium secondary battery described herein.

Other aspects of the invention are disclosed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows results of charging and discharging experiments of examples according to an exemplary embodiment of the present invention and comparative examples;

FIG. 2 shows a photograph of the surface of a silicon (SiO) particle, among negative electrode particles, after charging and discharging experiments of an example according to an exemplary embodiment of the present invention and comparative examples;

FIG. 3 shows a photograph of the surface of a graphite particle, among negative electrode particles, after charging and discharging experiments of an example according to an exemplary embodiment of the present invention and comparative examples;

FIG. 4 shows a photograph of the surface of a positive electrode particle after charging and discharging experiments of an example according to an exemplary embodiment of the present invention and comparative examples;

FIG. 5 shows an analysis graph of a positive electrode with respect to F is after charging and discharging experiments of an example according to an exemplary embodiment of the present invention and comparative examples;

FIG. 6 shows an analysis graph of a positive electrode with respect to Mn 2p after charging and discharging experiments of an example according to an exemplary embodiment of the present invention and comparative examples;

FIG. 7 shows an analysis graph of a positive electrode with respect to M-O after charging and discharging experiments of an example according to an exemplary embodiment of the present invention and comparative examples;

FIG. 8 shows an analysis graph of a negative electrode with respect to Mn 2p after charging and discharging experiments of an example according to an exemplary embodiment of the present invention and comparative examples; and

FIG. 9 shows a graph showing results of charging and discharging experiments of an example according to an exemplary embodiment of the present invention and comparative examples.

### DETAILED DESCRIPTION

Hereinafter, exemplary embodiments of the present invention will be described in detail with reference to the accompanying drawings. However, the present invention is not limited to the embodiments disclosed below and may be implemented in various different forms, and the embodiments herein are provided to make the disclosure of the present invention complete and to fully convey the scope of the invention to those skilled in the art.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to encompass the plural meaning as well, unless the context clearly indicates otherwise.

It will be further understood that terms such as “comprise” or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1% 0.05%, or 0.01% of the stated value. Unless otherwise clear from the context, all numerical values provided herein are modified by the term “about.”

In the present specification, when a range is described for a variable, it will be understood that, the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

An electrolytic solution for lithium secondary batteries according to an embodiment of the present invention, which is a material that forms an electrolyte applied to a lithium secondary battery, includes a lithium salt, a solvent, and a functional additive.

The lithium salt may suitably include one or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N (LiFSI), and (CF₃SO₂)₂NLi.

The lithium salt may be contained in the electrolytic solution so as to have a total molar concentration of 0.1 to 3.0.

The solvent may suitably include one or more selected from the group of a carbonate-based solvent, an ester-based solvent, an ether-based solvent, and a ketone-based solvent.

Dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (FEC), or vinylene carbonate (VC) may be suitably used as the carbonate-based solvent. γ-butyrolactone (GBL), n-methyl acetate, n-ethyl acetate, or n-propyl acetate may be suitably used as the ester-based solvent. Dibutyl ether may be suitably used as the ether-based solvent. However, the present invention is not limited thereto.

In addition, the solvent may further include an aromatic hydrocarbon-based organic solvent. Examples of the aromatic hydrocarbon-based organic solvent may include benzene, fluorobenzene, bromobenzene, chlorobenzene, cyclohexylbenzene, isopropylbenzene, n-butylbenzene, octylbenzene, toluene, xylene, and mesitylene, which may be used alone or in combination.

A first high-voltage additive, perfluoro-15-crown-5-ether, represented by [Formula 1] below and a second high-voltage additive, fluoroethylene carbonate, represented by [Formula 2] below may be used as the functional additive added to the electrolytic solution according to the embodiment of the present invention.

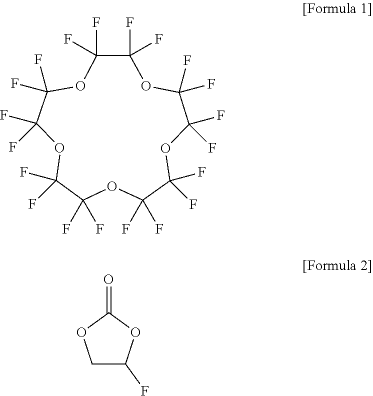 [SMILES: FC1(F)OC(F)(F)C(F)(F)OC(F)(F)C(F)(F)OC(F)(F)C(F)(F)OC(F)(F)C(F)(F)OC1(F)F ; O=C1OCC(F)O1]

The first high-voltage additive, i.e. perfluoro-15-crown-5-ether, serves to improve oxidative stability of the electrolytic solution and to form a protective layer on the surface of each of a positive electrode and a negative electrode, and may be added in an amount of about 0.2 to 1.5 wt % based on the total weight of the electrolytic solution. Preferably, the first high-voltage additive may be added in an amount of about 0.4 to 1.0 wt % based on the total weight of the electrolytic solution.

The second high-voltage additive represented by [Formula 2], i.e. fluoroethylene carbonate, serves to form a protective layer on the surface of the negative electrode, and may be added in an amount of about 0.5 to 2.5 wt % based on the total weight of the electrolytic solution. Preferably, the second high-voltage additive may be added in an amount of about 1.0 to 2.0 wt % based on the total weight of the electrolytic solution.

Consequently, the electrolytic solution may suitably include the high-voltage additive in an amount of about 0.7 to 4.0 wt % based on the total weight of the electrolytic solution. Preferably, the electrolytic solution may suitably include the high-voltage additive in an amount of about 1.4 to 3.0 wt % based on the total weight of the electrolytic solution.

When the addition amount of the high-voltage additive is less than about 0.7 wt %, or particularly less than about 1.4 wt %, the effect of improving oxidative stability of the electrolytic solution may be incomplete and formation of a sufficient surface protective layer may be difficult, whereby expected effects are incomplete. When the addition amount of the high-voltage additive is greater than about 4.0 wt %, or particularly greater than about 3.0 wt %, the resistance of a cell may be increased due to formation of an excessive surface protective layer, and lifespan of the cell may be reduced.

Meanwhile, a negative electrode film additive serving to form a film on the negative electrode may be further added as the functional additive. For example, Vinylene Carbonate (VC) may be used as the negative electrode film additive.

Preferably, the electrolytic solution may suitably include the negative electrode film additive in an amount of about 0.5 to 3.0 wt % based on the total weight of the electrolytic solution. Particularly, the electrolytic solution may suitably include the negative electrode film additive in an amount of about 1.5 to 2.5 wt %.

When the addition amount of the negative electrode film additive is less than about 0.5 wt %, the long-term lifespan characteristics of the cell may be deteriorated. When the addition amount of the negative electrode film additive is greater than about 3.0 wt %, the resistance of the cell is increased due to formation of an excessive surface protective layer, whereby battery output may be reduced.

In particular, the electrolytic solution may suitably include the functional additive including the first high-voltage additive, the second high-voltage additive, and the negative electrode film additive in an amount of about 5 wt % or less based on the total weight of the electrolytic solution.

A lithium secondary battery includes a positive electrode, a negative electrode, a separator, and the electrolytic solution as described herein.

The positive electrode includes an NCM-based positive electrode active material including Ni, Co, and Mn. Particularly, the positive electrode active material included in the positive electrode to include only an NCM-based positive electrode active material having about 80 wt % or greater of Ni.

The negative electrode includes at least one selected from among carbon (C)-based and silicon (Si)-based negative electrode active materials.

At least one selected from the group consisting of artificial graphite, natural graphite, graphitized carbon fiber, graphitized mesocarbon microbeads, fullerene, and amorphous carbon may be used as the carbon (C)-based negative electrode active material.

The silicon (Si)-based negative electrode active material includes silicon oxide, silicon particles, and silicon alloy particles.

Meanwhile, each of the positive electrode and the negative electrode may be manufactured by mixing an active material, a conductive agent, a binder, and a solvent with each other to manufacture an electrode slurry, directly coating a current collector with the electrode slurry, and drying the electrode slurry. At this time, aluminum (Al) may be used as the current collector. However, the present invention is not limited thereto. Such an electrode manufacturing method is well known in the art to which the present invention pertains, and therefore a detailed description thereof will be omitted.

The binder may properly attach active material particles to each other or to properly attach the active material particles to the current collector. For example, polyvinyl alcohol, carboxymethyl cellulose, hydroxypropyl methylcellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, or nylon may be used as the binder. However, the present invention is not limited thereto.

In addition, the conductive agent may provide conductivity to the electrode. The conductive agent is not particularly restricted as long as the conductive agent exhibits high electrical conductivity while the conductive agent does not induce any chemical change in a battery to which the conductive agent is applied. For example, natural graphite, artificial graphite, carbon black, acetylene black, Ketjen black, carbon fiber, metallic powder, such as copper powder, nickel powder, aluminum powder, or silver powder, or metallic fiber may be used as the conductive agent. In addition, conductive materials, such as polyphenylene derivatives, may be used alone or in combination.

The separator prevents short circuit between the positive electrode and the negative electrode and provides a movement path for lithium ions. A polyolefin-based polymer film, such as polypropylene, polyethylene, polyethylene/polypropylene, polyethylene/polypropylene/polyethylene, or polypropylene/polyethylene/polypropylene, a multilayer film thereof, a microporous film, woven fabric, or non-woven fabric, which are known, may be used as the separator. In addition, a porous polyolefin film coated with a resin having excellent stability may be used.

### EXAMPLE

Hereinafter, the present invention will be described through examples of the present invention and comparative examples.

### <Experiment 1> Experiment on Charging and Discharging Characteristics (Full Cell) at High Temperature (45° C.) Depending on Kind and Addition Amount of Functional Additive

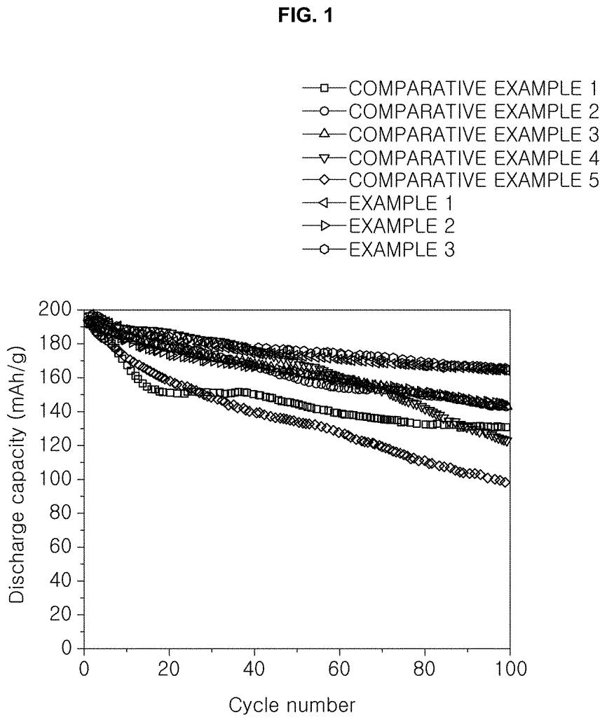

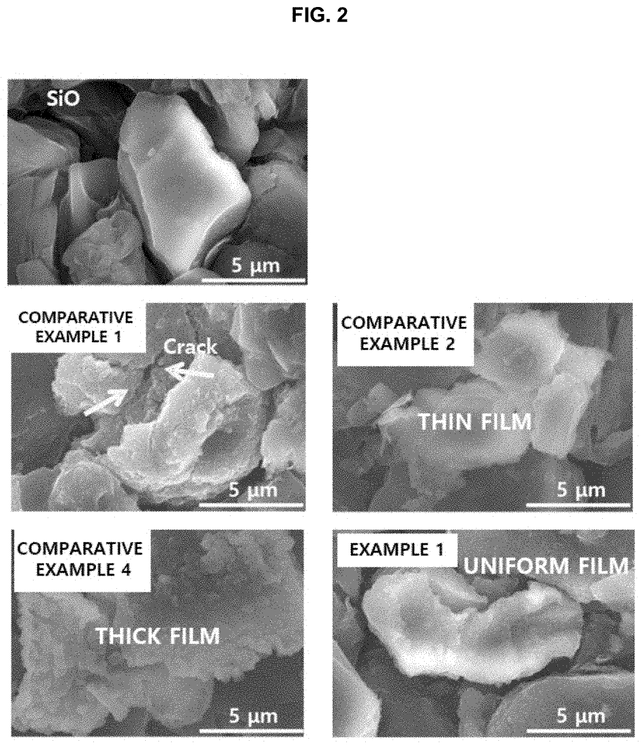

In order to determine charging and discharging characteristics depending on the kind and addition amount of a functional additive added to an electrolytic solution, the initial capacity at a high temperature (45° C.) and the capacity retention rate after 100 cycles were measured while the kind and addition amount of the functional additive were changed, as shown in Table 1 below, and the results are shown in Table 1 and FIG. 1. Also, in order to determine a positive electrode surface protection effect depending on addition of the functional additive added to the electrolytic solution, the surface of a positive electrode after 100 cycles was observed, and result photographs of the surfaces of a negative electrode particle and a positive electrode particle are shown in FIGS. 2 to 4.

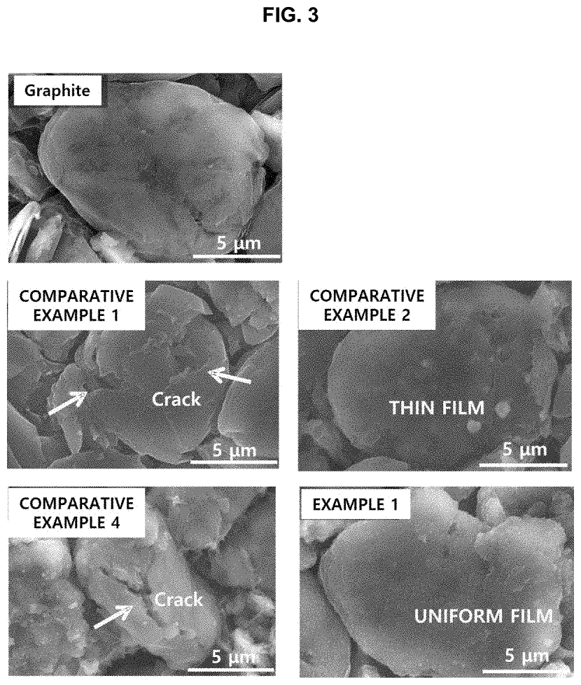

A result photograph of the surface of a silicon (SiO) particle and a result photograph of the surface of a graphite particle are shown in FIGS. 2 and 3, respectively.

At this time, cycles were performed at a voltage of 2.5 to 4.35V @ 1C and at a temperature of 45° C., 1M of LiPF₆ was used as a lithium salt necessary to manufacture the electrolytic solution, and a mixture of ethylene carbonate (EC), ethylmethyl carbonate (EMC), and diethyl carbonate (DEC) mixed at a volume ratio of 25:45:30 was used as a solvent.

NCM811 was used as a positive electrode, and graphite+SiO were used as a negative electrode.

TABLE 1

| | | | | Initial | Capacity |
|---|---|---|---|---|---|
| | Additive | | | capacity | retention |
| | | First | Second | @1 C | rate |
| | | high- | high- | 1st | @1 C |
| | | voltage | voltage | cycle | 100 cycles |
| Cl. | VC | additive | additive | (mAh/g) | (%) |
| Comparative | 2.0 | — | — | 191.4 | 68.2 |
| Example 1 | | | | | |
| Comparative | 2.0 | 0.4 | — | 196.4 | 72.9 |
| Example 2 | | | | | |
| Comparative | 2.0 | — | 1.0 | 197.6 | 72.7 |
| Example 3 | | | | | |
| Comparative | 2.0 | — | 2.0 | 197.2 | 62.3 |
| Example 4 | | | | | |
| Comparative | 2.0 | 0.1 | 2.0 | 195.0 | 50.4 |
| Example 5 | | | | | |
| Example 1 | 2.0 | 0.4 | 2.0 | 199.6 | 82.2 |
| Example 2 | 2.0 | 0.4 | 1.0 | 179.3 | 73.6 |
| Example 3 | 2.0 | 1.0 | 2.0 | 199.1 | 83.4 |

As shown in Table 1 and FIG. 1 that, in Examples 1 to 3, in which the kind and addition amount of the high-voltage additive according to the present invention were changed while a conventional general functional additive of VC was used, the capacity retention rate was improved, compared to Comparative Example 1, in which only VC was used.

Particularly, in Comparative Examples 2 and 3, in which one of a first high-voltage additive and a second high-voltage additive was selected and added, the capacity retention rate was improved, compared to Comparative Example 1, but was lower than in Examples 1 to 3.

Also, in Comparative Example 5, in which both the first high-voltage additive and the second high-voltage additive were added as the high-voltage additive but the addition amount of the first high-voltage additive was less than a reference value, the capacity retention rate was rather lower than in Comparative Example 1.

Consequently, it can be seen that, even when one of the first high-voltage additive and the second high-voltage additive is added as the functional additive, a capacity retention rate improvement effect is achieved, but it is preferable for both the first high-voltage additive and the second high-voltage additive to be added within a specified range of the addition amount.

FIG. 2 shows a result photograph of the surface of a silicon (SiO) particle, among negative electrode particles, after experiment on charging and discharging characteristics (full cell) at a high temperature (45° C.). As shown in FIG. 2, cracks were formed in the surface of the silicon particle in Comparative Example 1, a thin film was formed on the surface of the silicon particle in Comparative Example 2, and a thick film was formed on the surface of the silicon particle in Comparative Example 4.

In contrast, a uniform film was formed on the surface of the silicon particle in Example 1.

FIG. 3 shows a result photograph of the surface of a graphite particle, among negative electrode particles, after experiment on charging and discharging characteristics (full cell) at a high temperature (45° C.). As shown in FIG. 3, cracks were formed in the surface of the graphite particle in Comparative Example 1, a thin film was formed on the surface of the graphite particle in Comparative Example 2, and a thick film was formed on the surface of the graphite particle in Comparative Example 4, like the surface of the silicon particle.

In contrast, a uniform film was formed on the surface of the graphite particle in Example 1.

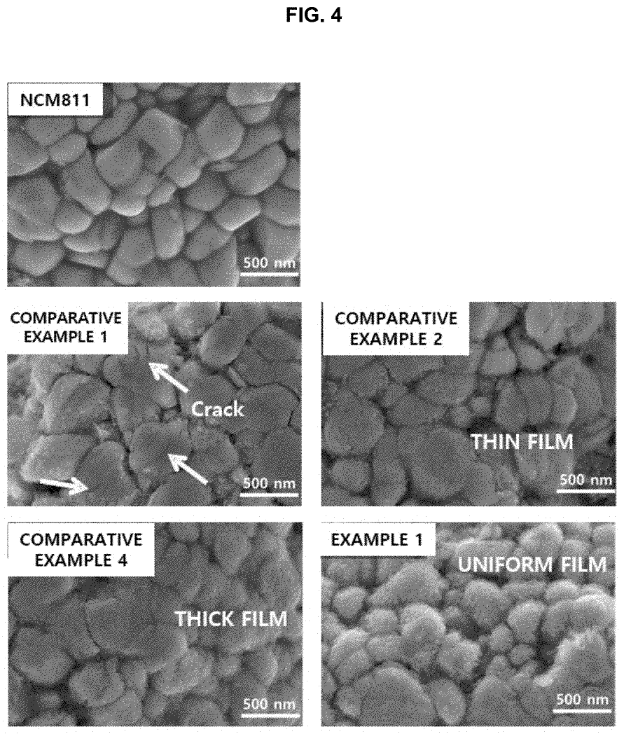

FIG. 4 shows a result photograph of the surface of a positive electrode particle after experiment on charging and discharging characteristics (full cell) at a high temperature (45° C.). As shown in FIG. 4 that cracks were formed in the surface of the positive electrode particle in Comparative Example 1, a thin film was formed on the surface of the positive electrode particle in Comparative Example 2, and a thick film was formed on the surface of the positive electrode particle in Comparative Example 4, like the surface of the negative electrode particle.

In contrast, a uniform film was formed on the surface of the positive electrode particle in Example 1.

### <Experiment 2> Analysis of Structures of Positive Electrode and Negative Electrode Surfaces after Experiment on Charging and Discharging Characteristics (Full Cell) at High Temperature (45° C.) Depending on Kind and Addition Amount of Functional Additive

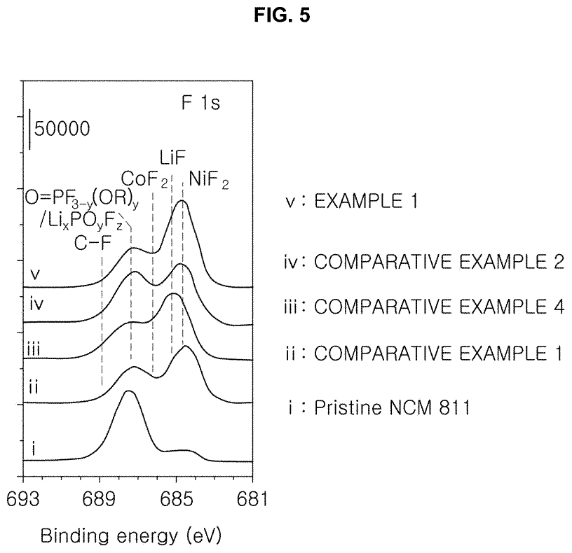

For Comparative Example 1, Comparative Example 2, Comparative Example 4, and Example 1 in Table 1, the surfaces of a positive electrode and a negative electrode were analyzed using X-ray photoelectron spectroscopy, and the results are shown in FIGS. 5 to 8.

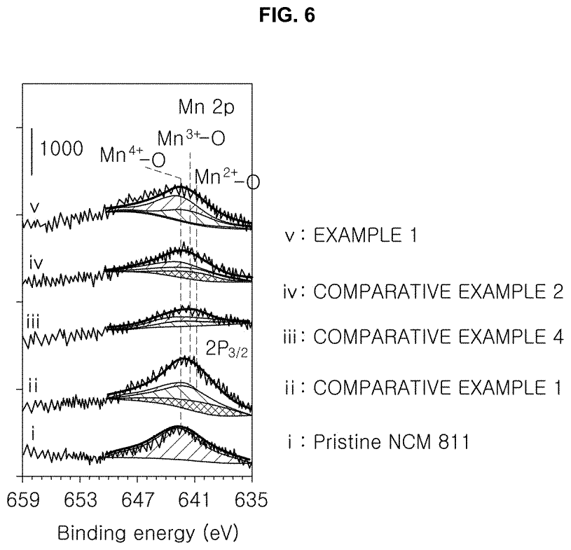

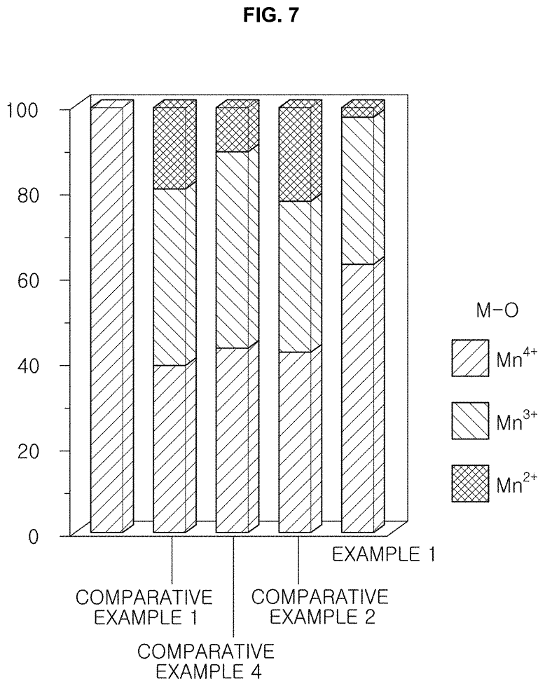

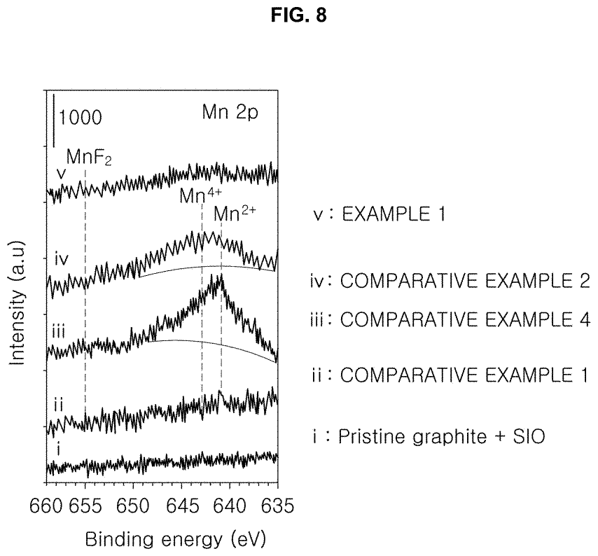

FIG. 5 shows an analysis graph of the positive electrode with respect to F 1s, FIG. 6 is an analysis graph of the positive electrode with respect to Mn 2p, FIG. 7 is an analysis graph of the positive electrode with respect to M-O, and FIG. 8 is an analysis graph of the negative electrode with respect to Mn 2p.

As shown in FIG. 5, in Example 1, NiF₂ and LiF, which are positive electrode surface film stabilization components, were generated in large quantities, whereby positive electrode surface film stability was improved.

Also, as shown in FIGS. 6 and 7, in Example 1, Mn²⁺—O formation fraction was low, whereby elution of manganese, which is responsible for structural stability of the positive electrode, was inhibited. Among manganese oxidation values (2+, 3+, and 4+), Mn²⁺ is a component that is eluted from a positive electrode structure to an electrolytic solution, thereby collapsing the positive electrode structure.

Also, as shown in FIG. 8 that the amount of Mn²⁺ eluted from the positive electrode, which is electrodeposited on the negative electrode, thereby increasing interfacial resistance of the negative electrode and reducing stability of a negative electrode film, in Example 1 was less than the amount of Mn²⁺ eluted from the positive electrode in Comparative Examples.

### <Experiment 3> Measurement of Thickness of Negative Electrode Before and After Experiment on Charging and Discharging Characteristics (Full Cell) at High Temperature (45° C.) Depending on Kind and Addition Amount of Functional Additive

Experiment on charging and discharging characteristics (full cell) at a high temperature (45° C.) were performed under the same conditions as in Experiment 1, the thickness of the negative electrode was measured before and after the experiments, and the results are shown in Table 2.

TABLE 2

| | Thickness of | Thickness of | Negative |
|---|---|---|---|
| | negative | negative | electrode |
| | electrode | electrode | thickness |
| | before | after | change |
| | cycle | cycle | rate |
| Classification | (μm) | (μm) | (%) |
| Comparative | 72 | 97 | Δ34.7 |
| Example 1 | | | |
| Comparative | 74 | 94 | Δ27.0 |
| Example 2 | | | |
| Comparative | 73 | 86 | Δ17.8 |
| Example 3 | | | |
| Comparative | 73 | 109 | Δ49.3 |
| Example 4 | | | |
| Comparative | 73 | 102 | Δ39.7 |
| Example 5 | | | |
| Example 1 | 71 | 88 | Δ23.9 |
| Example 2 | 73 | 89 | Δ21.9 |
| Example 3 | 76 | 88 | Δ15.8 |

As shown in Table 2 that, in Examples 1 to 3, in which the kind and addition amount of the high-voltage additive according to the present invention were changed while a conventional general functional additive of VC was used, the negative electrode thickness change rate was less than in Comparative Example 1, in which only VC was used.

Also, in Comparative Example 2, in which the first high-voltage additive was selected and added as the high-voltage additive, the negative electrode thickness change rate was less than in Comparative Example 1 but was greater than in Examples 1 to 3.

Particularly, in Comparative Example 4, in which the second high-voltage additive was selected and added as the high-voltage additive but the addition amount of the second high-voltage additive was large, and Comparative Example 5, in which both the first high-voltage additive and the second high-voltage additive were added as the high-voltage additive but the addition amount of the first high-voltage additive was less than the reference value, the negative electrode thickness change rate was rather greater than in Comparative Example 1.

Consequently, even in terms of the negative electrode thickness change rate, it is preferable for both the first high-voltage additive and the second high-voltage additive, as the high-voltage additive added as the functional additive, to be added within a specified range of the addition amount.

### <Experiment 4> Experiment on Charging and Discharging Characteristics (Full Cell) at High Temperature (45° C.) Depending on Kind and Addition Amount of Functional Additive

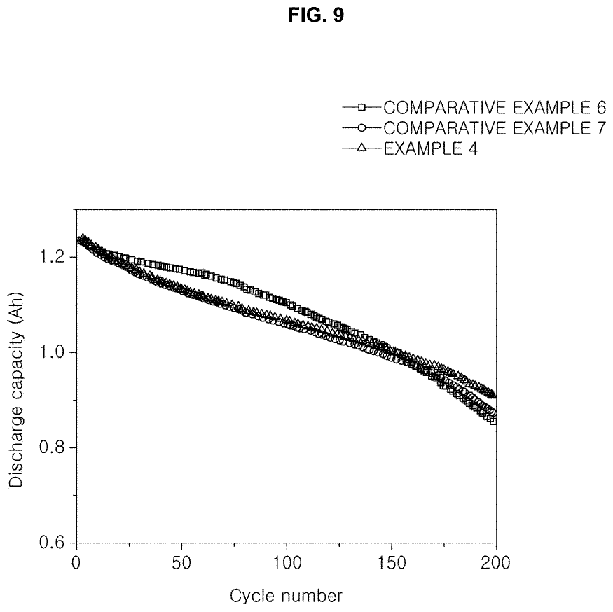

In order to determine charging and discharging characteristics depending on the kind and addition amount of a functional additive added to a reference electrolytic solution including changed components, compared to Experiment 1, the initial capacity at a high temperature (45° C.) and the capacity retention rate after 100 cycles were measured while the kind and addition amount of the functional additive were changed, as shown in Table 3 below, and the results are shown in Table 3 and FIG. 9.

At this time, cycles were performed at a voltage of 2.5 to 4.35V @ 1C and a temperature of 45° C., 0.5 LiFSI+0.5M LiPF₆ were used as a lithium salt necessary to manufacture the electrolytic solution, and a mixture of ethylene carbonate (EC), ethylmethyl carbonate (EMC), and diethyl carbonate (DEC) mixed at a volume ratio of 25:45:30 was used as a solvent.

NCM811 was used as a positive electrode, and graphite+SiO were used as a negative electrode.

TABLE 3

| | | | | Initial | Capacity |
|---|---|---|---|---|---|
| | Additive | | | capacity | retention |
| | | First | Second | @1 C | rate |
| | | high- | high- | 1st | @1 C |
| | | voltage | voltage | cycle | 100 cycles |
| Cl. | VC | additive | additive | (Ah/g) | (%) |
| Comparative | 2.0 | — | — | 1.24 | 68.8 |
| Example 6 | | | | | |
| Comparative | 2.0 | — | 2.0 | 1.24 | 70.2 |
| Example 7 | | | | | |
| Example 4 | 2.0 | 0.4 | 2.0 | 1.25 | 72.6 |

As shown in Table 3 and FIG. 9, in Example 4, in which the kind and addition amount of the high-voltage additive according to the present invention were applied while a conventional general functional additive of VC was used, the capacity retention rate was improved, compared to Comparative Example 6, in which only VC was used, and Comparative Example 7, in which the second high-voltage additive was selected and added as the high-voltage additive.

As is apparent from the above description, according to various exemplary embodiments of the present invention, an electrolytic solution including a high-voltage additive may be used, and oxidative stability of a 4.4 V electrolytic solution can be secured. Consequently, side reactivity at a high voltage may be prevented, whereby the long-term lifespan characteristics of a lithium secondary battery may be improved.

In addition, degradation of the surface of a positive electrode may be prevented and stability of a negative electrode film may be improved by the electrolytic solution, whereby the lifespan of the lithium secondary battery is increased.

Furthermore, lifespan stability of the battery at high temperature and high voltage may be secured, whereby marketability of the battery is improved.

Although the present invention has been described with reference to the accompanying drawings and the above preferred embodiment, the present invention is not defined thereby but by the appended claims. Accordingly, it will be apparent to those skilled in the art that various modifications and variations can be made in the present invention without departing from the technical idea of the appended claims.

What is claimed is:

1. An electrolytic solution for lithium secondary batteries, comprising a lithium salt, a solvent, and a functional additive, wherein
the functional additive comprises a high-voltage additive constituted by a mixture of a first high-voltage additive, perfluoro-15-crown-5-ether, represented by [Formula 1] and a second high-voltage additive, fluoroethylene carbonate, represented by [Formula 2].

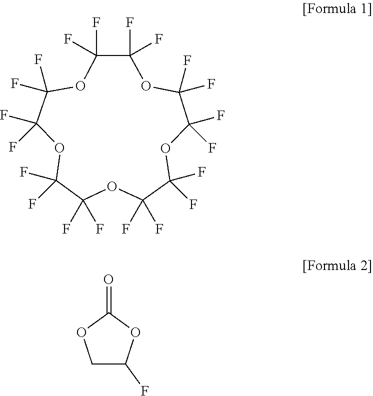 [SMILES: FC1(F)OC(F)(F)C(F)(F)OC(F)(F)C(F)(F)OC(F)(F)C(F)(F)OC(F)(F)C(F)(F)OC1(F)F ; O=C1OCC(F)O1]

2. The electrolytic solution according to claim 1, wherein the electrolytic solution comprises the high-voltage additive in an amount of about 0.7 to 4.0 wt % based on the total weight of the electrolytic solution.

3. The electrolytic solution according to claim 2, wherein:
the electrolytic solution comprises the first high-voltage additive in an addition amount of 0.2 to 1.5 wt % based on the total weight of the electrolytic solution, and
the electrolytic solution comprises the second high-voltage additive in an amount of about 0.5 to 2.5 wt % based on the total weight of the electrolytic solution.

4. The electrolytic solution according to claim 2, wherein the electrolytic solution comprises the high-voltage additive in an amount of about 1.4 to 3.0 wt % based on the total weight of the electrolytic solution.

5. The electrolytic solution according to claim 4, wherein:
the electrolytic solution comprises the first high-voltage additive in an amount of about 0.4 to 1.0 wt % based on the total weight of the electrolytic solution, and
the electrolytic solution comprises the second high-voltage additive in an amount of about 1.0 to 2.0 wt % based on the total weight of the electrolytic solution.

6. The electrolytic solution according to claim 1, wherein the functional additive further comprises vinylene carbonate (VC) as a negative electrode film additive.

7. The electrolytic solution according to claim 6, wherein the electrolytic solution comprises the negative electrode film additive in an amount of 0.5 to 3.0 wt % based on the total weight of the electrolytic solution.

8. The electrolytic solution according to claim 7, wherein the electrolytic solution comprises the functional additive in an amount of about 5 wt % or less based on the total weight of the electrolytic solution.

9. The electrolytic solution according to claim 8, wherein:
the electrolytic solution comprises the first high-voltage additive in an amount of about 0.4 to 1.0 wt % based on the total weight of the electrolytic solution,
the electrolytic solution comprises the second high-voltage additive in an amount of about 1.0 to 2.0 wt % based on the total weight of the electrolytic solution, and
the electrolytic solution comprises the negative electrode film in an amount of about 1.5 to 2.5 wt % based on the total weight of the electrolytic solution.

10. The electrolytic solution according to claim 1, wherein the lithium salt comprises one or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N (LiFSI), and (CF₃SO₂)₂NLi.

11. The electrolytic solution according to claim 1, wherein the solvent comprises one or more selected from the group consisting of a carbonate-based solvent, an ester-based solvent, an ether-based solvent, and a ketone-based solvent.

12. A lithium secondary battery comprising the electrolytic solution according to claim 1.

13. The lithium secondary battery according to claim 12, further comprising:
a positive electrode comprising a positive electrode active material comprising Ni, Co, and Mn;
a negative electrode comprising one or more selected from among carbon (C)-based and silicon (Si)-based negative electrode active materials; and
a separator interposed between the positive electrode and the negative electrode.

14. The lithium secondary battery according to claim 13, wherein the positive electrode comprises the Ni in an amount of about 80 wt % or greater based on the total weight of the positive electrode.

15. A vehicle comprising a lithium secondary batter according to claim 12.
